(19) United States
(12) Patent Application Publication
(10) Pub. No.: US 2026/0322594 A1
(43) Pub. Date: Oct. 15, 2026

(54) POST-QUANTUM SAFE MUTUAL AUTHENTICATION COMMUNICATION SYSTEMS

(71) Applicant: Microsoft Technology Licensing, LLC, Redmond, WA (US)

(72) Inventors: Eran Chencinski, Giv'at Shmuel (IL); Oren Istrin, Tel Aviv (IL); Shoham Dekel, Tel Aviv (IL)

(21) Appl. No.: 19/178,615

(22) Filed: Apr. 14, 2025

(51) Int. Cl. H04L 9/08; H04L 9/32; G06F 21/44; G06F 21/60

(52) U.S. Cl. CPC H04L 9/0852; H04L 9/3273; G06F 21/445; G06F 21/606

(57) ABSTRACT

Devices, systems, and methods for post-quantum (PQ) secure (PQS) communications are provided. A method includes authenticating, by a device and with a first server, using a legacy device identity, receiving and installing, by the device, a firmware upgrade that provides the device an ability to communicate in a PQS manner, establishing a PQS communication channel between the device and a second server, mutually authenticating, by the device and with the second server, using a PQ identity (PQI) of the device, the PQI different from the legacy identity, and responsive to successful mutual authentication, communicating between the device and the second server, using the PQS communication channel.

### BACKGROUND

The advent of quantum computers poses a serious challenge to the security of the existing public-identity key cryptosystems, as they can be potentially broken based on Shor’s algorithm. Post-quantum cryptography (PQC) aims to develop cryptographic algorithms that are secure against quantum computer attacks.

### SUMMARY

An improved method to handle identities in a post-quantum (PQ) world uses multiple identities, one for non-PQ communications prior to having the ability to establish PQ secure (PQS) connections and one for use after gaining the ability to establish PQ secure connections. Since the ability to establish PQ secure connections can be gained from a firmware update, it is possible to securely use a legacy device (a device deployed before PQS communication channels are possible) in a PQ world in a secure manner. After an ability to establish PQS communication channels is established, the PQ identity (PQI) can be used and the legacy identity can be discarded or no longer used to identify the device.

A method can include authenticating, by a device and with a first server, using a legacy device identity. The method can include receiving and installing, by the device, a firmware upgrade that provides the device an ability to communicate in a post-quantum (PQ) secure (PQS) manner. The method can include establishing a PQS communication channel between the device and a second server. The method can include mutually authenticating, by the device and with the second server, using a PQ identity (PQI) of the device, the PQI different from the legacy identity. The method can include, responsive to successful mutual authentication, communicating between the device and the second server, using the PQS communication channel.

The method can include responsive to successful mutual authentication, preventing access to the legacy identity. Preventing access to the legacy identity occurs responsive to receiving, by the device, biometric data indicating an authorized user is physically present.

Mutually authenticating can include providing a temporary PQI hash-based public identity key to the second server and establishing a long-term PQI after successful authentication with the second server. Mutually authenticating can include, before providing a certificate and proof from the device to the second server, receiving a certificate and proof from the second server and verifying the identity of the second server. The PQI can include a value associated with a leaf of a Merkle tree. The method can further include determining, by the device, that the second server is capable of establishing the PQS communication channel based on a certificate from the second server.

While the subject matter is summarized in terms of a method, the subject matter can be implemented using a system, device, a machine-readable medium, or a combination thereof.

### BRIEF DESCRIPTION OF DRAWINGS

FIG. 1 illustrates, by way of example, a diagram of an embodiment of a device that includes both PQC and non-PQC (NPQC) identities.

FIG. 2 illustrates, by way of example, a diagram of an embodiment of a method for authentication in a PQC environment.

FIG. 3 illustrates, by way of example, a communication diagram of operations and communications in performing the authentication with post-quantum identity (PQI) operation.

FIG. 4 illustrates, by way of example, a communication diagram of an embodiment of provisioning a long-term PQI.

FIG. 5 illustrates, by way of example, a diagram of an embodiment of system for PQC mutual authentication.

FIG. 6 illustrates, by way of example, a block diagram of an embodiment of a method for establishing a post-quantum secure (PQS) communication channel.

FIG. 7 illustrates, by way of example, a block diagram of an embodiment of a machine (e.g., a computer system) to implement one or more embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the embodiments. It is to be understood that other embodiments may be utilized and that structural, logical, and/or electrical changes may be made without departing from the scope of the embodiments. The following description of embodiments is, therefore, not to be taken in a limited sense, and the scope of the embodiments is defined by the appended claims.

Suppose a user or administrator understands that quantum computers (QC) are going to be available and ready for use in the future. Suppose also, that the user or administrator has a hardware system that they want to deploy now, but they want the hardware system to be secure from QC eavesdropping, harvest now decrypt later attacks, and against identity theft. They may be delivering the hardware system before QC and corresponding secure communication channels are available. Further, they know that whatever they have deployed in the field before QC can have their identities compromised after QC. The identity that was provided in the factory can easily be compromised post QC (PQC).

In a mutual authentication scenario, each device involved in the mutual authentication must have a unique identity. This identity is set in the factory. Generating an identity remotely exposes the device to identity theft by bad actors impersonating as the server.

Also consider a server that is upgraded to a PQ secure (PQS) communication channel from a non-PQ secure communication channel. The hardware system will not have an identity that is guaranteed to be uncompromised and can be used in the PQS communications.

An improved method to handle identities in a PQ world uses multiple identities, one for non-PQ communications prior to having the ability to establish PQ secure connections (such as by using CRYSTALS Dilithium) and one for use after gaining the ability to establish PQ secure connections. Since the ability to establish PQ secure connections can be gained from a firmware update, it is possible to securely use a legacy device (a device deployed before PQS communication channels are possible) in a PQ world in a secure manner. After an ability to establish PQS communication channels is established, the PQ identity (PQI) can be used and the legacy identity can be discarded or no longer used to identify the device.

Note that devices are not currently configured to implement CRYSTALS Dilithium because the implementation of PQC techniques, such as CRYSTALS Dilithium, are still in its early stages. The runtime support for these PQC techniques is not yet mature enough to justify implementation in current devices. The transition to PQC involves significant changes to existing cryptographic infrastructure, which can be complex and time-consuming. There are also hardware limitations and performance limitations in some devices that prevent transition to PQC techniques.

The transition to PQC requires coordination across various stakeholders, including hardware manufacturers, software developers, and regulatory bodies. The certification procedures for PQC algorithms are still being established. Organizations like NIST are working on standardizing these algorithms, but the process is ongoing and expected to take several more years. The complexity of transitioning to PQC is higher than previous cryptographic migrations, such as the transition from SHA-1, which took over a decade. There is a need for clear guidelines and regulations to facilitate the adoption of PQC. The lack of standardized certification processes makes it difficult for organizations to comply with PQC requirements.

There are also technical and logistical issues in transitioning to PQC techniques. The integration of PQC algorithms into existing systems requires significant changes to cryptographic application programming interfaces (APIs) and certificate formats. There are also logistical challenges related to the provisioning and management of PQC identity keys and certificates during device manufacturing and deployment.

Improved methods provide secure communications and cryptographic systems in a PQ world. The improved methods manage mutual authentication within a secure connection to facilitate both post-quantum and non-post-quantum communications.

Post-quantum cryptography (PQC) aims to develop cryptographic algorithms that are secure against quantum computer attacks. However, during the transition period between non-post-quantum cryptography (NPQC) (also called legacy cryptography herein), systems must support both post-quantum (possibly more than one) and NPQC methods. There is a need for a secure and efficient way to manage multiple identities, such as within a trusted platform module (TPM), to enable seamless communication across both PQC and NPQC paradigms.

Embodiments hold and manage two distinct cryptographic identities (one or more NPQC identities and one or more PQC identities) within a root of trust (e.g., a TPM module). The PQC identity is reserved strictly for use in PQCs. The NPQC identity is reserved strictly for use in NPQCs. Each device, in embodiments, thus has multiple identities unique to itself. This multi-identity approach is typically provisioned in the system on chip (SoC) or device manufacturing and is matched in a backend/database. The multiple identities are not necessarily post-quantum (PQ) safe, but at least one identity is reserved for use only over a PQ secure connection.

After establishing a secure PQC connection, the device only sends the PQC tagged identity after verifying the PQC identity of the server, thus preventing an attack to leak the PQ identity by a false server.

Embodiments can benefit at least 3 types of situations:
Certain software applications will have PQ capabilities after the SoC launches (with delay);
Certain applications will have PQ capabilities and others will not; and
One of the identities will be saved for remote provisioning for a PQS identity.

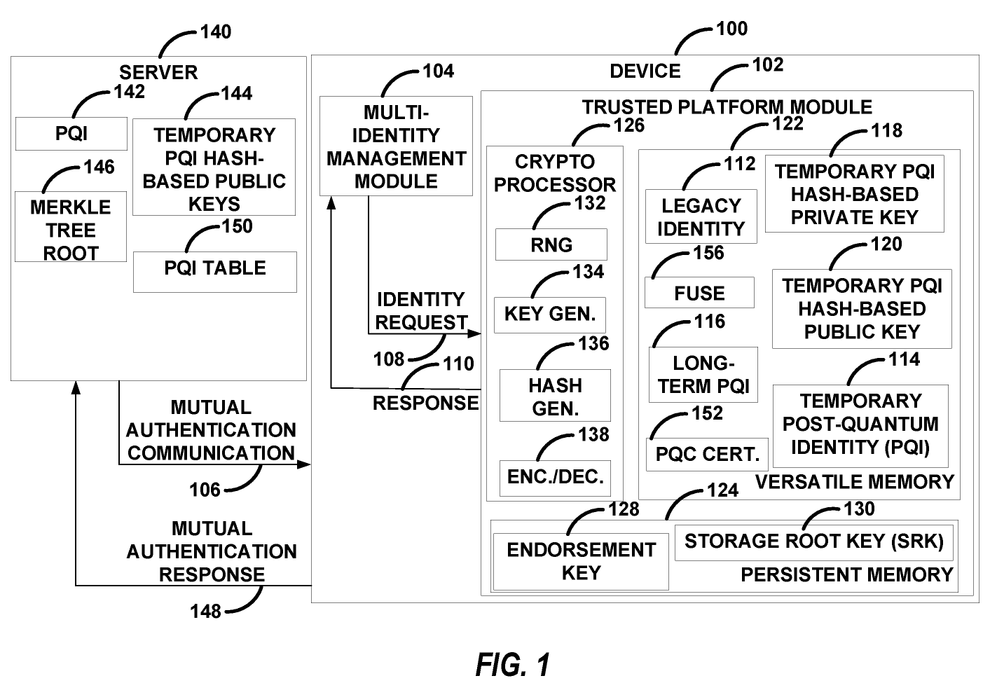

FIG. 1 illustrates, by way of example, a diagram of an embodiment of a device 100 that includes both PQC and NPQC identities. The device 100 as illustrated includes a trusted platform module (TPM) 102 communicatively coupled to a multi-identity management module (MIMM) 104.

The TPM 102 includes a secure crypto-processor 126 that implements the International Organization for Standards (ISO)/International Electrotechnical Commission (IEC) 11889 standard in one example. Common uses for the TPM 102 include verifying that the boot process starts from a trusted combination of hardware and software and storing disk encryption identity keys. The TPM 102 serves as the foundational security element for the device 100. The TPM 102 is responsible for storing and protecting cryptographic identity keys and identities and providing safe cryptographic services to different clients, such as by a crypto processor 126.

The TPM 102 is an SoC, a chip, that includes a variety of communicatively coupled hardware elements. The TPM 102 as illustrated includes a versatile memory 122, a crypto-processor 126, and a persistent memory. The versatile memory 122 includes a plurality of identities to be used by the device 100 in establishing a secure connection with another device using a mutual authentication communication 106. The identities include an NPQI 112, a temporary PQI 114, and a long-term PQI 116. Some optional identities are also illustrated and include a temporary PQI hash-based public identity key 120, and a temporary PQI hash-based private identity key 118.

The device 100, starts with communication connections that are not PQC secure and uses the legacy identity 112 to establish a secure mutual authentication communications channel with a server 140. The communications 106 and 148 are provided over the communications channel.

After both the server and the device 100 have a capability (e.g., hardware and firmware) to support both PQC secure communications and the server has a PQI 142 (e.g., a PQC certificate) in place, the device 100 (e.g., by server certification) may move to remote PQC provisioning of a new PQC identity, the long-term PQI 116. The remote provisioning can be done over a secure PQC connection and after the validation of the PQI 142 of the server 140. At this point, the device 100 can safely send the temporary PQI 114 over the secure PQC communication channel such as through a response 148.

The server 140 verifies the temporary PQI 114 against a table 150 that stores the known temporary PQIs of a client 126 to identify the specific device. The table 150 can be stored, while in the factory, during the provision phase of the temporary PQIs for each device.

After the client 126 is verified, the device 100 and the server 140 can negotiate the long-term PQI 116. The long-term PQI 116 can be negotiate by:
a. The device 100 generates a PQC private/public identity key pairs, such as by a identity key generator 134
b. The device 100 generates a PQC certificate 152 with the public identity key therein
c. The device 100 sends the certificate 152 to the server 140 to be signed by the server 140
d. The server 140 signs the certificate using the PQI 142 and sends it back to the device 100
e. The client stores this certificate along side the long-term PQI 116

The NPQI 112 is generated at the factory and stored in the versatile memory 122 before shipping of the TPM 102. The temporary PQI 114 is also generated at the factory and stored in the versatile memory 122 before shipping of the TPM 102. The long-term PQI 116 is generated by the device 100 as part of a mutual authentication performed based on the temporary PQI 114. The long-term PQI 116 is typically not present when the device 100 is shipped, but is instead a non-populated memory entry when the device 100 ships. The long-term PQI 116 is then generated later when a post-quantum (PQ) secure communication channel is being established between the device 100 and another device that is capable of communicating using the PQC secure communication channel (e.g., a certification server).

The temporary PQI hash-based private identity key 118 can be used in place of the temporary PQI identity key 114. The temporary PQI identity key 114 is a symmetric secret that both the client and the server 140 needs to know (e.g., store) for mutual authentication. If one wants an authentication server to avoid storing all the temporary PQI identity keys 114, they can use an asymmetric identity key scheme which is hash-based. Hash-based PQC algorithm are established as they use standard hashing algorithms, but they suffer from two main problems in practice: 1) the hash-based PQC algorithms are limited in the number of times one can use them, and 2) the hash-based PQC algorithms are hard to maintain as the private identity keys requires state preservation.

However, if one uses the hash-based PQC algorithm only for one time identity key, and uses the temporary hash-based PQCI 114 only once to upgrade to a PQC algorithm which does not have the above limitations, one can avoid storing all the temporary PQI identities in the certification server.

One time identification authentication using the temporary PQI hash- based private identity key 118 and the temporary PQI hash-based public identity key 120 can be performed as follows:
a. The sever stores the temporary PQI hash-based public identity key 120
b. The device 100 stores both the temporary PQI hash-based private identity key 118 (each client with a unique identity key) and, optionally, the temporary PQI hash-based public identity key 120
c. Before the remote long-term PQI 116 provisioning, the device 100 will prove its identify to the server via the temporary PQI hash-based private identity key 118, and the sever will verify the identity via the corresponding temporary PQI hash-based public identity key 120

To further improve use of the temporary PQI hash-based private identity key 118 and the temporary PQI hash-based public identity key 120 and to avoid the server saving temporary PQI hash-based public identity keys 120 for each and every device, a Merkle tree can be used during provisioning in the factory to give every single device one of the leaf identity keys of the Merkle tree. The provisioning in the factory can also include data indicating a position of the leaf identity key in the Merkle tree. Using such a scheme the server 140 will only need to store the root of the Merkle tree and will be able to verify all the clients. The clients will only store one hash based PQC identity key and the location of the leaf identity key in the Merkle tree, and the intermediate tree nodes can be sent via software as they are public identity keys. Leighton-Micali Signature (LMS) and Xtended Merkle Signature Scheme (XMSS) are examples of asymmetric techniques for digitally signing with Merkle tree based signatures. These techniques can only support a limited number of signatures.

The TPM 102 further includes a persistent memory 124 that includes an endorsement identity key 128 and a storage root identity key 130. The endorsement identity key 128 (EK) is a fundamental component of the TPM 102. The EK 128 is also something unique to the TPM 102 which is not found on a smart card device. The TPM 102 has an EK 128 pair, of which the private identity key is embedded in the TPM 102 and never leavesit. The public EK is contained in a certificate and is only used in a limited number of procedures. The reason for limiting the use of the EK 128 certificate is because the EK 128 is unique to each TPM 102 and consequently may be used to identify the device 100. Therefore, to protect user privacy when interacting with other entities, the use of the EK 128 is restricted and internally generated aliases, the identity keys and other identities in the versatile memory 122 are used for more routine transactions.

TPM manufacturers will provide the EK pair and store this in tamper resistant persistent memory before shipping the TPM 102. A certificate, or endorsement credential,can then be created which contains the public EK and information about the security properties of the TPM 102. This endorsement credential should be signed by a certification authority, known as the TPME or Trusted Platform Module Entity, who can attest to the fact that the identity key contained in the certificate is a public EK whose corresponding private EK is stored in the TPM 102 that conforms to the TCG standards. This TPME may be a third party or, if authorized to do so, it may be the manufacturer themselves.

The storage root identity key 130 (SRK) is also stored in the persistent memory 124. This identity key also never leave this secure storage during normal operation. A third type of identity key, the Attestation Identity key (AIK), the identity keys in the versatile memory 122, may also be stored within the TPM 102. These identity keys may be regarded as an alias for the EK 128. Each TPM 102 can support many AIKs, thus the user can have many unlinkable identity keys that can be used to maintain anonymity between different service providers who require proof of identity. These AIKs must, therefore, be persistent and although they could be stored on the TPM 102 non-volatile memory, for practical reasons the standards recommend keeping the AIK identity keys in secure external storage. The TPM 102, however, provides a volatile storage area where one or more AIK identity keys can be loaded when in use.

The hash generator 136 can, for example, generate secure hash algorithm (SHA)-1 cryptographic hashes or other cryptographic hashes. The hash generator 136 hashes the input data and produces a digest. The hash generator 136 also forms the basis of an Hash Based Message Authentication Code (HMAC) engine, and is used in a number of cryptographic procedures carried out by the TPM 102, for example: in the computation of digital signatures and for creating identity key objects where a hash of the identity key may be required as part of an integrity protection mechanism.

The identity key generator 134 generating cryptographic identity keys suitable for use with the TPM 102. Rivest-Shavir-Adleman (RSA) is an example algorithm that can be implemented by the identity key generator 134. The identity key generation performed by the identity key generator 134 can be a computationally intensive task and since such identity keys are widely used in the TPM 102, for signing and providing secure storage, the standard specifies that the TPM should include a module specifically for this task. The standard requires that the TPM 102 is able to support identity keys up to a 2048 bit modulus. Moreover, there are certain identity keys used with the TPM 102 that must have at least a 2048 bit modulus. The RSA algorithm can also be used for signing, encryption, and decryption, such as by the encryption/decryption engine 138. Maintaining the principle of identity key separation, the TPM 102 uses dedicated signing identity keys for signing data, and separate storage identity key pairs for encryption and decryption by the encryption/decryption engine 138.

Multi-identity management (MIM) module 104 is responsible for coordinating the use of PQI and NPQI based on the communication context. The MIM module 104 indicates to the TPM 102 the identity to be used in an identity request 108. The TPM 102 acknowledges the identity will be used in a response 110. If the communication is capable of being provided over a PQI secure connection, the MIM does not use the legacy identity 112 and instead instructs the TPM 102 to use one or more of the long-term PQI 116, PQC cert 152, temporary PQI hash-based private identity key 118, temporary PQI hash-based public identity key 120, or temporary PQI 114 to establish the PQI secure connection. Otherwise the TPM 102 is instructed to use the legacy identity 112. The MIM module 104 ensures that the appropriate identity is used for each communication session.

The device 100 can revoke the legacy identity 112, forcing use of only PQIs. The legacy identity 112 can be stored in a memory location that is associated with a fuse 156. Fuses in memory devices are small, programmable storage elements that can be set to a specific state (typically on or off) and then retain that state even when power is removed. The fuse 156 indicates whether the entry in the legacy identity 112 is valid or invalid. If the legacy identity is invalid, the MIM module 104 can determine that a PQI is to be used. The fuse 156 can be electrically programmable and located in a specific section of non-volatile memory and consist of a few registers, where each bit represents a different fuse setting.

The MIM module 104 can determine whether the PQI is to be used based on one or more conditions. The one or more conditions can include: receiving a firmware upgrade to communicate using a PQS communication technique; a PQS communication channel being established prior to changing a value of the fuse; certification was received via a PQS communication; physical presence of an authorized user of the device 100; or a combination thereof. A memory entry can indicate whether a PQS communication channel has been established by the device 100. If the memory entry remains unasserted, for example, that can indicate that the device 100 has not established a PQS communication channel. If the memory entry is asserted, for example, that can indicate that the device 100 has established a PQS communication channel in the past. The MIM module 104 then knows that PQS communication channels can be established and the PQI of the device 100 is to be used. Another memory entry can indicate whether a PQS certification was received over a PQS communication channel. If the memory entry remains unasserted, for example, that can indicate that the device 100 has not received the PQC certificate 152 over a PQS communication channel. If the memory entry is asserted, for example, that can indicate that the device 100 has received the PQS certificate 152 over the PQS communication channel. Physical presence can include the user performing biometric validation (e.g., facial recognition, fingerprint recognition, iris recognition, or the like), a password entered on a identity keypad, or the like. If the user is determined to be physically present, the value of the fuse 156 can be changed to indicate that PQI is to be used going forward.

A PQS communication connection can be implemented using a PQC cryptography technique. PQC cryptography techniques include lattice-based cryptography (e.g., CRYSTALS-Kyber, CRYSTALS-Dilithium, FALCON, SABER, among others), code-based cryptography (e.g., Classica McEliece, BIKE, HQC, among others), hash-based cryptography (e.g., SPHINCS+, LMS, XMSS, among others), multivariate quadratic equations (e.g., Rainbow, GeMSS, among others), Isogeny-based cryptography (e.g., SIKE), or zero-knowledge proofs (e.g., PICNIC). These are currently known PQC techniques that each have advantages and disadvantages. While identity key establishment, using a PQS cryptography technique, PQC certification is not currently supported.

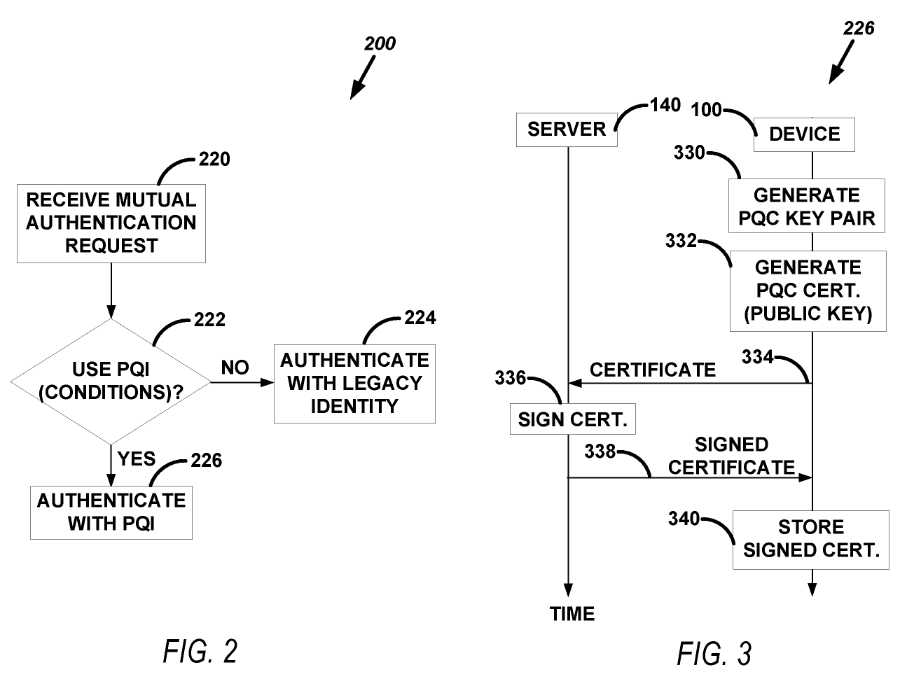

FIG. 2 illustrates, by way of example, a diagram of an embodiment of a method 200 for authentication in a PQC environment. The method 200 can be implemented by the device 100 or the server 140. The method 200 as illustrated includes receiving a mutual authentication request at operation 220. Mutual authentication means that both the device 100 and a recipient are authenticating to each other. Usually, only the device 100 authenticates the recipient. In mutual authentication, both the device 100 and the recipient are authenticating each other. At operation 222, it can be determined whether PQI is to be used in the mutual authentication. The PQI is a cryptographic that is to be used only in a PQS communication channel. The operation 222 can include determining whether one or more conditions are met. Possible conditions were discussed previously with regard to the MIM module 104. If PQI is to be used, the device 100/server 140 and the recipient can authenticate with each other using the PQI over a PQS channel at operation 226. If PQI is not to be used, the device 100/server 140 and the recipient can authenticate with each other using the legacy identity 112 over a non-PQS channel at operation 224.

FIG. 3 illustrates, by way of example, a communication diagram of operations and communications in performing the operation 226. The example of FIG. 3 illustrates the operations 226 performed between the example device 100 and example server 140. The operation 226 as illustrated includes the device 100 generating a PQC identity key pair at operation 330. The PQC identity key pair includes a public identity key and a private identity key used to encrypt/decrypt data, sign a communication, or the like, in a PQS manner. The identity keys 118, 120, 114, and 116 are examples of PQS identity keys.

At operation 332, the device 100 generates a PQC certificate 334 with the public identity key embedded therein. The certificate 334 can include device 100 data that helps ensure that the device 100 is indeed the device 100, data about the public identity key, and a digital signature generated based on a corresponding private identity key. The certificate 334 can be communicated, via a PQS or non-PQS communication channel to the server 140. The server 140 can sign the certificate at operation 336. The signature by the server 140 can be decrypted by the device 100 using a corresponding public identity key (that could be shared previously). The signed certificate 338 is provided to the device 100. The device 100 stores the signed certificate at operation 340.

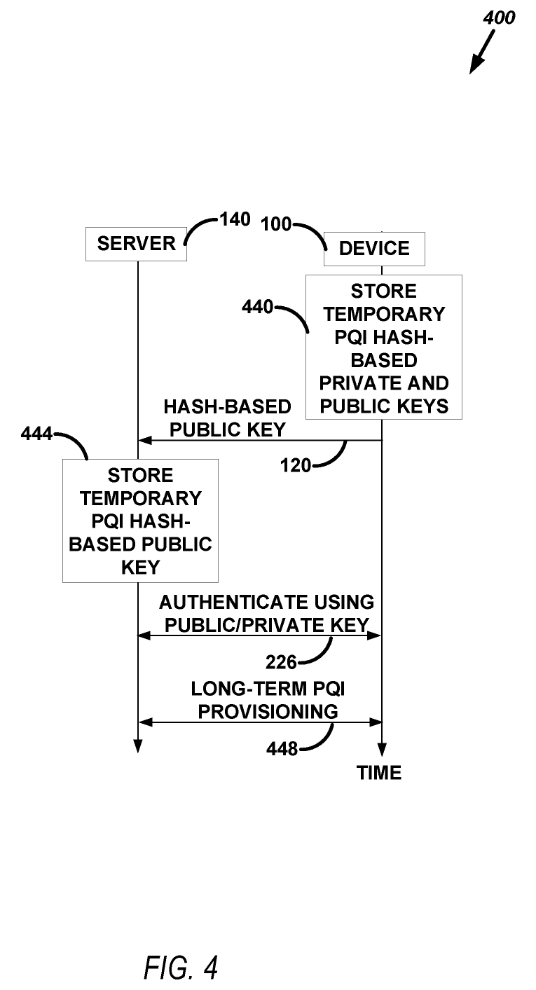

FIG. 4 illustrates, by way of example, a communication diagram of an embodiment of a method 400 for provisioning of a long-term PQI. The long-term PQI 114 can be generated responsive to determining one or more specified conditions are met. An ability to establish a PQS communication channel between the device 100 and a recipient is required before generating the PQI 114. To start, the device 100 stores the temporary PQI hash-based public identity key 120 and the temporary PQI hash-based private identity key 118 locally at operation 440. The device 100 provides the temporary PQI hash-based public identity key 120 to the server 140. The server 140 stores the temporary PQI hash-based public identity key 120 at operation 444. The server 140 can then use the temporary PQI hash-based public identity key 120 to authenticate the device 100. The device 100 and server 140 perform authentication (e.g., certificate generation and verification using exchanged public identity keys). The temporary PQI hash-based public identity key 120 and the temporary PQI hash-based private identity key 118 can be replace using a long-term PQI provisioning operation 448. The operation 448 can include the device 100 providing a PQI identity key or numbers, from which, a corresponding long-term PQI public identity key can be derived. The device 100 can generate a private identity key and encrypt data using the private identity key to prove to the server that the device 100 is indeed itself. The server 140 can decrypt the data using the public identity key to verify that the device 100 is indeed itself.

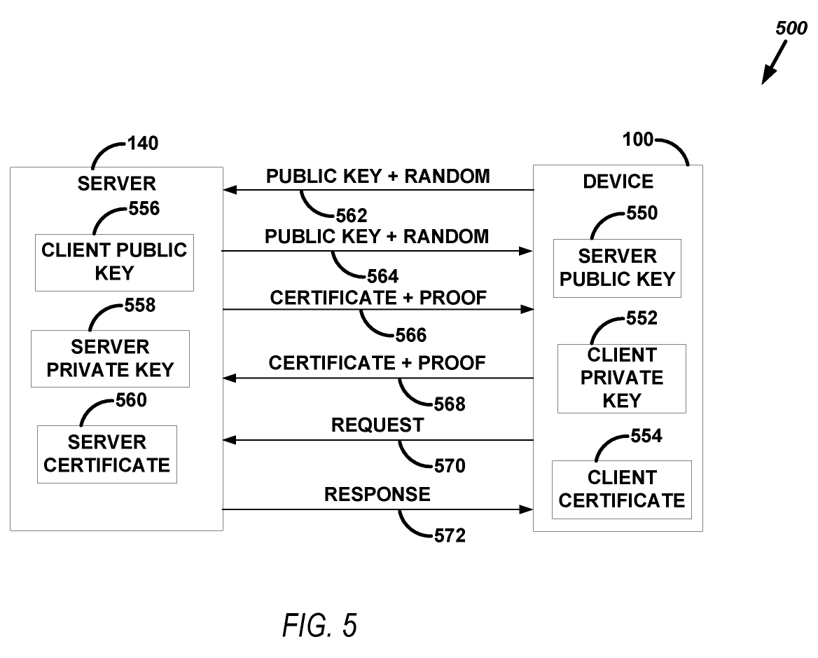

FIG. 5 illustrates, by way of example, a diagram of an embodiment of system 500 for PQC mutual authentication. The system 500 as illustrated includes the device 100 and the server 140 sharing a series of communications. The series of communications include identity key exchange (communications 562, 564), attestation (communications 566, 568), and PQS encrypted data communication (communications 570, 572). The server 140 receives a public identity key 556 from the device 100 in communication 562. The communication 562 can further include random data, such as a random number generated by random number generator 132. The server 140 can store the client public identity key 556 for decrypting future encrypted communications from the device 100. The public identity key 556 can be the long-term PQI 114.

The device 100 receives a public identity key 550 from the server 140 in communication 564. The communication 564 can further include random data, such as a random number generated by a random number generator of the server 140. The device 100 can store the public identity key 550 for decrypting future encrypted communications from the server 140.

The server 140 can provide a certificate 560 and identity proof in communication 566. The identity proof can include server 140 identity data encrypted using a server private identity key 558. The server private identity key 558 and the server public identity key 550 form a cryptographic identity key pair. The device 100 can decrypt the proof using the server public identity key 550 and verify the proof is coming from the server 140.

The device 100 can provide a certificate 554 and identity proof in communication 568. The identity proof can include device 100 identity data encrypted using a device private identity key 552. The device private identity key 552 and the device public identity key 556 form a cryptographic identity key pair. The server 140 can decrypt the proof using the client public identity key 556 and verify the proof is coming from the device 100.

After successful mutual attestation, the device 100 and the server 140 can communicate over a PQS communication channel. The device 100 can issue a request 570 for access to data, a service, or the like in a PQS communication 570. The server 140 can issue a response to the request that includes the requested data, service results, or the like in a PQS communication 572.

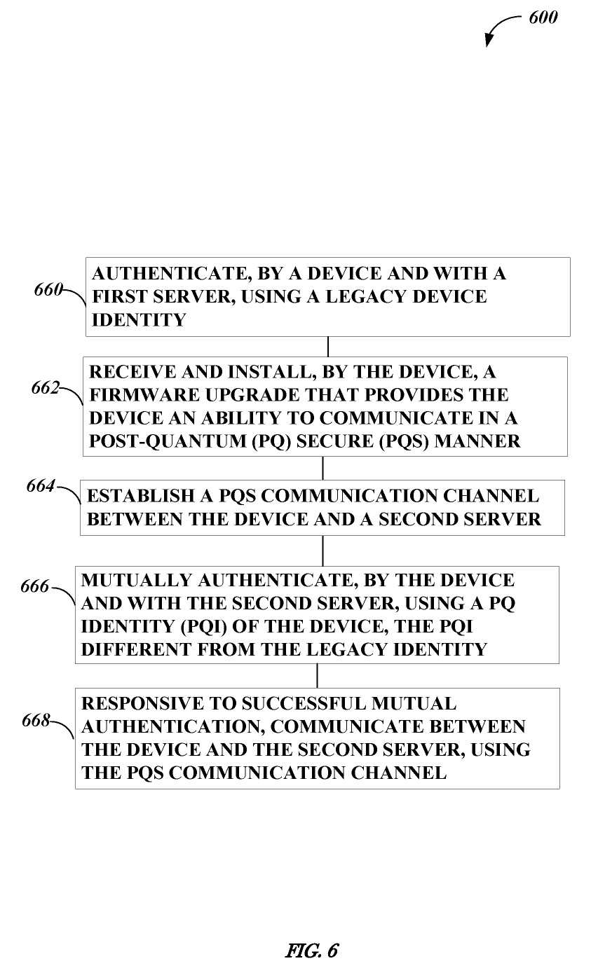

FIG. 6 illustrates, by way of example, a block diagram of an embodiment of a method 600 for PQS communication. The method 600 as illustrated includes authenticating, by a device and with a first server, using a legacy device identity, at operation 660; receiving and installing, by the device, a firmware upgrade that provides the device an ability to communicate in a post-quantum (PQ) secure (PQS) manner, at operation 662; establishing a PQS communication channel between the device and a second server, at operation 664; mutually authenticating, by the device and with the second server, using a PQ identity (PQI) of the device, the PQI different from the legacy identity, at operation 666; and responsive to successful mutual authentication, communicating between the device and the second server, using the PQS communication channel, at operation 668.

The method 600 can further include responsive to successful mutual authentication, preventing access to the legacy identity. Preventing access to the legacy identity can occur responsive to receiving, by the device, biometric data indicating an authorized user is physically present.

The operation 666 can include providing a temporary PQI hash-based public identity key to the second server and establishing a long-term PQI after successful authentication with the second server. The operation 666 can include before providing a certificate and proof from the device to the second server, receiving a certificate and proof from the second server and verifying the identity of the second server. The PQI can include a value associated with a leaf of a Merkle tree. The method 600 can further include determining, by the device, that the second server is capable of establishing the PQS communication channel based on a certificate from the second server.

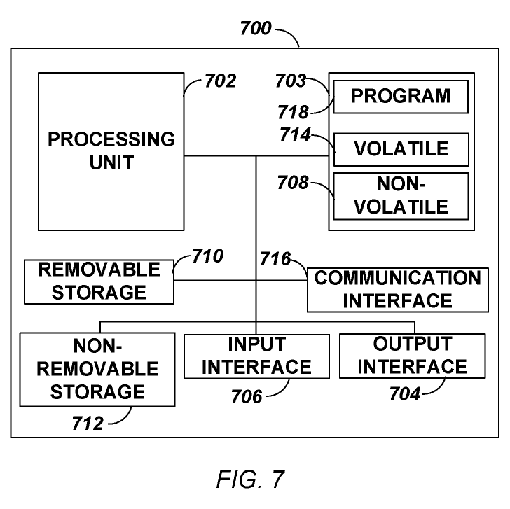

FIG. 7 illustrates, by way of example, a block diagram of an embodiment of a machine 700 (e.g., a computer system) to implement one or more embodiments. Any of the device 100, server 140, method 200, method 400, system 500, method 600 or a component or operation thereof can include one or more of the components of the machine 700. One or more of the Any of the device 100, server 140, method 200, method 400, system 500, method 600 or a component or operation thereof can include one or more of the components of the machine 700, or a component or operations thereof can be implemented, at least in part, using a component of the machine 700. One example machine 700 (in the form of a computer), may include a processing unit 702, memory 703, removable storage 710, and non-removable storage 712. Although the example computing device is illustrated and described as machine 700, the computing device may be in different forms in different embodiments. For example, the computing device may instead be a smartphone, a tablet, smartwatch, or other computing device including the same or similar elements as illustrated and described regarding FIG. 7. Devices such as smartphones, tablets, and smartwatches are generally collectively referred to as mobile devices. Further, although the various data storage elements are illustrated as part of the machine 700, the storage may also or alternatively include cloud-based storage accessible via a network, such as the Internet.

Memory 703 may include volatile memory 714 and non-volatile memory 708. The machine 700 may include – or have access to a computing environment that includes – a variety of computer-readable media, such as volatile memory 714 and non-volatile memory 708, removable storage 710 and non-removable storage 712. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices capable of storing computer-readable instructions for execution to perform functions described herein.

The machine 700 may include or have access to a computing environment that includes input 706, output 704, and communication circuitry 716. Output 704 may include a display device, such as a touchscreen, that also may serve as an input device. The input 706 may include one or more of a touchscreen, touchpad, mouse, identity keyboard, camera, one or more device-specific buttons, one or more sensors integrated within or coupled via wired or wireless data connections to the machine 700, and other input devices. The computer may operate in a networked environment using a communication connection to connect to one or more remote computers, such as database servers, including cloud-based servers and storage. The remote computer may include a personal computer (PC), server, router, network PC, a peer device or other common network node, or the like. The communication connection may include a Local Area Network (LAN), a Wide Area Network (WAN), cellular, Institute of Electrical and Electronics Engineers (IEEE) 802.11 (Wi-Fi), Bluetooth, or other networks.

Computer-readable instructions stored on a computer-readable storage device are executable by the processing unit 702 (sometimes called processing circuitry) of the machine 700. A hard drive, CD-ROM, and RAM are some examples of articles including a non-transitory computer-readable medium such as a storage device. For example, a computer program 718 may be used to cause processing unit 702 to perform one or more methods or algorithms described herein.

The communication circuitry 716 can include a radio, such as a transceiver, configured to communicate wirelessly with other devices. The communication circuitry 716 can include one or more antennas, modulators, demodulators, amplifiers, digital to analog converters, analog to digital converters, phase locked loops, a combination thereof, or the like. The communication circuitry 716 is configured to format and transmit communications to other devices.

The operations, functions, or algorithms described herein may be implemented in software in some embodiments. The software may include computer executable instructions stored on computer or other machine-readable media or storage device, such as one or more non-transitory memories (e.g., a non-transitory machine-readable medium) or other type of hardware based storage devices, either local or networked. Further, such functions may correspond to subsystems, which may be software, hardware, firmware, or a combination thereof. Multiple functions may be performed in one or more subsystems as desired, and the embodiments described are merely examples. The software may be executed on a digital signal processor, ASIC, microprocessor, central processing unit (CPU), graphics processing unit (GPU), field programmable gate array (FPGA), or other type of processor operating on a computer system, such as a personal computer, server or other computer system, turning such computer system into a specifically programmed machine. The functions or algorithms may be implemented using processing circuitry, such as may include electric and/or electronic components (e.g., one or more transistors, resistors, capacitors, inductors, amplifiers, modulators, demodulators, antennas, radios, regulators, diodes, oscillators, multiplexers, logic gates, buffers, caches, memories, GPUs, CPUs, field programmable gate arrays (FPGAs), or the like).

### Additional Notes and Examples

Example 1 includes a method comprising authenticating, by a device and with a first server, using a legacy device identity, receiving and installing, by the device, a firmware upgrade that provides the device an ability to communicate in a post-quantum (PQ) secure (PQS) manner, establishing a PQS communication channel between the device and a second server, mutually authenticating, by the device and with the second server, using a PQ identity (PQI) of the device, the PQI different from the legacy identity, and responsive to successful mutual authentication, communicating between the device and the second server, using the PQS communication channel.

In Example 2, Example 1 further includes responsive to successful mutual authentication, preventing access to the legacy identity.

In Example 3, Example 2 further includes, wherein preventing access to the legacy identity occurs responsive to receiving, by the device, biometric data indicating an authorized user is physically present.

In Example 4, at least one of Examples 1-3 further includes, wherein mutually authenticating includes providing a temporary PQI hash-based public identity key to the second server and establishing a long-term PQI after successful authentication with the second server.

In Example 5, at least one of Examples 1-4 further includes, wherein mutually authenticating includes, before providing a certificate and proof from the device to the second server, receiving a certificate and proof from the second server and verifying the identity of the second server.

In Example 6, at least one of Examples 1-5 further includes, wherein the PQI includes a value associated with a leaf of a Merkle tree.

In Example 7, at least one of Examples 1-6 further includes determining, by the device, that the second server is capable of establishing the PQS communication channel based on a certificate from the second server.

Example 8 includes a non-transitory machine-readable medium including instructions that, when executed by a machine, cause the machine to perform operations comprising authenticating, with a first server, using a legacy device identity, receiving and installing, by the device, a firmware upgrade that provides the device an ability to communicate in a post-quantum (PQ) secure (PQS) manner, establishing a PQS communication channel with a second server, mutually authenticating, with the second server, using a PQ identity (PQI) of the device, the PQI different from the legacy identity, and responsive to successful mutual authentication, communicating with the second server, using the PQS communication channel.

In Example 9, Example 8 further includes, wherein the operations further comprise responsive to the successful mutual authentication, preventing access to the legacy identity.

In Example 10, Example 9 further includes, wherein preventing access to the legacy identity occurs responsive to receiving biometric data indicating an authorized user is physically present.

In Example 11, at least one of Examples 8-10 further includes, wherein mutually authenticating includes providing a temporary PQI hash-based public identity key to the second server and establishing a long-term PQI after successful authentication with the second server.

In Example 12, at least one of Examples 8-11 further includes, wherein mutually authenticating includes, before providing a certificate and proof from the device to the second server, receiving a certificate and proof from the second server and verifying the identity of the second server.

In Example 13, at least one of Examples 8-12 further includes, wherein the PQI includes a value associated with a leaf of a Merkle tree.

In Example 14, at least one of Examples 8-13 further includes, wherein the operations further comprise determining, by the device, that the second server is capable of establishing the PQS communication channel based on a certificate from the second server.

Example 15 includes a device comprising a trusted platform module (TPM) including a legacy device identity and a post-quantum (PQ) identity (PQI) stored thereon, communications circuitry, processing circuitry, and a memory, including instructions that, when executed by the processing circuitry, cause the processing circuitry to perform operations comprising authenticating, via the communications circuitry and with a first server, using the legacy device identity, receiving, via the communications circuitry and installing, a firmware upgrade that provides the device an ability to communicate in a post-quantum (PQ) secure (PQS) manner, establishing, via the communications circuitry, a PQS communication channel with second server, mutually authenticating, by the communications circuitry and with the second server, using the PQI, and responsive to successful mutual authentication, communicating via the communications circuitry with the second server, using the PQS communication channel.

In Example 16, Example 15 further includes, wherein the operations further comprise responsive to successful mutual authentication, preventing access to the legacy identity.

In Example 17, Example 16 further includes, wherein preventing access to the legacy identity occurs responsive to receiving biometric data indicating an authorized user is physically present.

In Example 18, at least one of Examples 15-17 further includes, wherein mutually authenticating includes providing a temporary PQI hash-based public identity key to the second server and establishing a long-term PQI after successful mutual authentication with the second server.

In Example 19, at least one of Examples 15-18 further includes, wherein mutually authenticating includes, before providing a certificate and proof from the device to the second server, receiving a certificate and proof from the second server and verifying the identity of the second server.

Although a few embodiments have been described in detail above, other modifications are possible. For example, the logic flows depicted in the figures do not require the order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A method comprising:
authenticating, by a device and with a first server, using a legacy device identity;
receiving and installing, by the device, a firmware upgrade that provides the device an ability to communicate in a post-quantum (PQ) secure (PQS) manner;
establishing a PQS communication channel between the device and a second server;
mutually authenticating, by the device and with the second server, using a PQ identity (PQI) of the device, the PQI different from the legacy identity; and
responsive to successful mutual authentication, communicating between the device and the second server, using the PQS communication channel.

2. The method of claim 1, further comprising:
responsive to successful mutual authentication, preventing access to the legacy identity.

3. The method of claim 2, wherein preventing access to the legacy identity occurs responsive to receiving, by the device, biometric data indicating an authorized user is physically present.

4. The method of claim 1, wherein mutually authenticating includes providing a temporary PQI hash-based public identity key to the second server and establishing a long-term PQI after successful authentication with the second server.

5. The method of claim 1, wherein mutually authenticating includes, before providing a certificate and proof from the device to the second server, receiving a certificate and proof from the second server and verifying the identity of the second server.

6. The method of claim 1, wherein the PQI includes a value associated with a leaf of a Merkle tree.

7. The method of claim 1, further comprising determining, by the device, that the second server is capable of establishing the PQS communication channel based on a certificate from the second server.

8. A non-transitory machine-readable medium including instructions that, when executed by a machine, cause the machine to perform operations comprising:
authenticating, with a first server, using a legacy device identity;
receiving and installing, by the device, a firmware upgrade that provides the device an ability to communicate in a post-quantum (PQ) secure (PQS) manner;
establishing a PQS communication channel with a second server;
mutually authenticating, with the second server, using a PQ identity (PQI) of the device, the PQI different from the legacy identity; and
responsive to successful mutual authentication, communicating with the second server, using the PQS communication channel.

9. The non-transitory machine-readable medium of claim 8, wherein the operations further comprise:
responsive to the successful mutual authentication, preventing access to the legacy identity.

10. The non-transitory machine-readable medium of claim 9, wherein preventing access to the legacy identity occurs responsive to receiving biometric data indicating an authorized user is physically present.

11. The non-transitory machine-readable medium of claim 8, wherein mutually authenticating includes providing a temporary PQI hash-based public identity key to the second server and establishing a long-term PQI after successful authentication with the second server.

12. The non-transitory machine-readable medium of claim 8, wherein mutually authenticating includes, before providing a certificate and proof from the device to the second server, receiving a certificate and proof from the second server and verifying the identity of the second server.

13. The non-transitory machine-readable medium of claim 8, wherein the PQI includes a value associated with a leaf of a Merkle tree.

14. The non-transitory machine-readable medium of claim 8, wherein the operations further comprise determining, by the device, that the second server is capable of establishing the PQS communication channel based on a certificate from the second server.

15. A device comprising:
a trusted platform module (TPM) including a legacy device identity and a post-quantum (PQ) identity (PQI) stored thereon;
communications circuitry;
processing circuitry; and
a memory, including instructions that, when executed by the processing circuitry, cause the processing circuitry to perform operations comprising:
authenticating, via the communications circuitry and with a first server, using the legacy device identity;
receiving, via the communications circuitry and installing, a firmware upgrade that provides the device an ability to communicate in a post-quantum (PQ) secure (PQS) manner;
establishing, via the communications circuitry, a PQS communication channel with second server;
mutually authenticating, by the communications circuitry and with the second server, using the PQI; and
responsive to successful mutual authentication, communicating via the communications circuitry with the second server, using the PQS communication channel.

16. The device of claim 15, wherein the operations further comprise:
responsive to successful mutual authentication, preventing access to the legacy identity.

17. The device of claim 16, wherein preventing access to the legacy identity occurs responsive to receiving biometric data indicating an authorized user is physically present.

18. The device of claim 15, wherein mutually authenticating includes providing a temporary PQI hash-based public identity key to the second server and establishing a long-term PQI after successful mutual authentication with the second server.

19. The device of claim 15, wherein mutually authenticating includes, before providing a certificate and proof from the device to the second server, receiving a certificate and proof from the second server and verifying the identity of the second server.

20. The device of claim 15, wherein the operations further comprise determining, by the device, that the second server is capable of establishing the PQS communication channel based on a certificate from the server.
